(19) United States
(12) Patent Application Publication
(10) Pub. No.: US 2026/0167476 A1
(43) Pub. Date: Jun. 18, 2026

(54) SAFETY SYSTEM FOR A HANDLING MACHINE

(71) Applicant: MANITOU BF, ANCENIS (FR)

(72) Inventor: Valentin BREHIER, ANCENIS (FR)

(21) Appl. No.: 19/407,588

(22) Filed: Dec. 3, 2025

(30) Foreign Application Priority Data
Dec. 13, 2024 (FR) 2414040

(51) Int. Cl. B66F 17/00; B66F 9/06; B66F 9/075

(52) U.S. Cl. CPC B66F 17/003; B66F 9/063; B66F 9/0755

(57) ABSTRACT

The invention relates to a safety system for a handling machine comprising:
a controller (32, 271, 202, 19) configured to:
   determine a stability state of the handling machine;
   determine an allowable deceleration of the handling machine based on the stability state, the allowable deceleration being capable of stopping the handling machine without causing the handling machine to tip over;
   determine a minimum stopping distance based on a current travel speed of the handling machine and the permissible deceleration,
   determine a maximum permissible stopping distance;
   in response to determining that the minimum stopping distance is or becomes greater than the maximum permissible stopping distance, transmit a signal to an element of the handling machine to reduce the travel speed.

### TECHNICAL FIELD

The invention relates to the field of safety systems for a handling machine, and in particular to the field of anti-tipping systems, anti-collision systems and braking systems. In particular, the invention relates to the field of systems for preventing a handling machine from tipping over during braking.

The invention finds particular application in handling machines comprising a main body mounted on wheels for moving on the ground, a handling arm for receiving a load to be moved, the handling arm being articulated about a horizontal axis relative to the main body, and an actuating device configured to execute a movement of the handling arm relative to the main body, the actuating device comprising a hydraulic lifting cylinder mounted between the handling arm and the main body to execute a movement of the handling arm about the horizontal axis.

Such a machine may be implemented in particular in the form of a telescopic arm forklift truck, a lifting crane, an aerial work platform, a bucket loader or other.

### TECHNICAL BACKGROUND

A handling machine may include an anti-collision system to prevent unintended collisions with objects such as other machines, people or structures. Such an anti-collision system may include a sensor for detecting objects and controlling one or more braking devices to prevent the handling machine from colliding with a detected object.

However, at certain speeds at the time of braking, excessive deceleration may be applied to the handling machine based on the command from the anti-collision system. This excessive deceleration then causes an undesirable forward tilt in the direction of travel.

It is desirable to avoid such a situation.

Publication US202215083 proposes an anti-collision system that slows down or stops a handling machine in response to the detection of an obstacle, taking into account the requirement for stability during braking.

### SUMMARY OF THE INVENTION

A basic idea behind the invention is to adjust the travel speed of the handling machine so that the handling machine is capable of stopping safely at any time.

The invention provides a safety system for a handling machine, the safety system comprising:
a controller configured to:
   determine a stability state of the handling machine,
   determine an allowable deceleration of the handling machine based on the stability state, the allowable deceleration being capable of stopping the handling machine without causing the handling machine to tip over,
   determine a minimum stopping distance based on a current travel speed of the handling machine and the permissible deceleration,
   determining a maximum permissible stopping distance,
   in response to determining that the minimum stopping distance or a reference stopping distance dependent on the minimum stopping distance is or becomes greater than the maximum permissible stopping distance, transmitting an adaptation signal to an element of the handling machine to reduce the current travel speed so that the minimum stopping distance or the reference stopping distance becomes or remains less than or equal to the maximum permissible stopping distance.

According to embodiments, such a safety system may comprise one or more of the following features.

Certain aspects of the invention are based on the idea of taking into account the location data of the handling machine.

In particular, an idea underlying certain aspects of the invention is to take into account a relative position of the handling machine in its environment or an absolute position of the handling machine to determine a speed of movement of the machine that ensures that the handling machine is capable of stopping safely at any time.

To this end, according to one embodiment, the safety system further comprises a location system configured to acquire location data of the handling machine, and the controller is configured to determine the maximum permissible stopping distance based on the location data of the handling machine.

Thanks to these features, it is possible to ensure that the handling machine is capable of stopping safely at all times under the conditions imposed by the location of the handling machine, in particular by complying with the road regulations applicable to the current position of the handling machine.

According to one embodiment, the computer is configured to determine the maximum permissible stopping distance based on weather conditions in a geographical area and/or the number of handling machines present in a geographical area, the geographical area being determined from the location data of the handling machine.

According to one embodiment, the computer is configured to determine the maximum permissible stopping distance based on timestamp data.

According to one embodiment, the location system is adapted to determine a relative or absolute position of the telescopic arm forklift truck, and the computer is capable of determining the maximum permissible stopping distance based on the relative or absolute position of the telescopic arm forklift truck.

For example, the computer determines the maximum permissible stopping distance defined by regulations applicable to the relative or absolute position of the handling machine.

According to one embodiment, the location system comprises one or more environmental sensors configured to recognize a traffic sign and a regulatory indication contained in the traffic sign.

Thanks to these features, the location system can determine the relative location of the machine in relation to elements in its environment, in particular in relation to road signs, and extract information from the analysis of these images, for example regulatory information.

Thus, the computer can determine the maximum permissible stopping distance based on the regulatory indication contained in the traffic sign.

According to one embodiment, the computer is configured to determine the maximum permissible stopping distance based on the absolute location of the handling machine and one or more pieces of regulatory information applicable to that absolute location, the regulatory information being contained in one or more databases accessible by the computer.

According to one embodiment, the location system comprises a satellite geolocation positioning system or a GSM geolocation positioning system using mobile phone network antennas and technologies designed for voice and data transfer, such as GSM, UMTS or LTE.

Certain aspects of the invention are based on the idea of taking into account the detection range of certain sensors on the handling machine.

In particular, an idea underlying certain aspects of the invention is to take into account the coverage zone of a distance determination sensor to determine a travel speed for the handling machine that ensures that the handling machine is capable of stopping safely at any time.

To this end, according to one embodiment, the safety system comprises a distance determination sensor intended to be installed in the handling machine, the distance determination sensor being configured to determine a distance between the handling machine and an object positioned in a coverage zone, the computer being configured to determine the maximum permissible stopping distance based on a representative dimension of the coverage zone of the distance determination sensor.

According to one embodiment, the distance determination sensor comprises one or more object sensors configured to generate an object signal indicating the detection of all or part of an object in the coverage zone, the distance determination sensor being configured to determine the distance between the handling machine and the object positioned within the coverage zone based on the object signals generated by the object sensor(s).

According to one embodiment, the object sensor(s) are each characterized by a perception zone, the object sensor(s) being capable of detecting an object positioned within their perception zone, the coverage zone being the union of the perception zones.

According to one embodiment, the object sensor(s) comprise one or more imagers, one or more light detection and ranging (LIDAR) sensors, one or more sound navigation (SONAR) sensors, and/or one or more radio detection and ranging (RADAR) sensors.

According to one embodiment, the representative dimension of the coverage zone is within one of the following ranges: [0 m; 175 m], [0 m; 150 m], [0 m; 125 m], [0 m; 100 m], [0 m; 75 m], [0 m; 50 m], [0 m; 25 m].

According to one embodiment, the at least one representative dimension of the coverage zone is a representative dimension forming a zero angle with the direction of movement of the handling machine.

According to one embodiment, the at least one representative dimension of the coverage zone is a smallest dimension among a plurality of representative dimensions of the coverage zone.

For example, the at least one representative dimension of the coverage zone is selected by the computer taking into account the current speed of the handling machine.

According to one embodiment, the at least one representative dimension of the coverage zone is predetermined and stored in a database accessible by the computer.

According to one embodiment, the safety system further comprises an anti-collision system configured to automatically detect a risk of collision with an object positioned in the coverage zone of the handling machine based on the distance between the handling machine and the object positioned in the coverage zone and to activate a braking system of the handling machine in order to reduce the speed of the handling machine and avoid the collision or mitigate its consequences.

Such a safety system may provide that the reference stopping distance exceeds the minimum stopping distance by a safety distance or safety margin. In this case, the reference stopping distance is, for example, an activation distance corresponding to the sum of the minimum stopping distance and the safety distance. The safety distance is determined, for example, by taking into account the reaction time of the handling machine component.

According to one embodiment, the safety system comprises a tilt sensor, for example arranged at a rear axle of the handling machine. According to one embodiment, the tilt sensor is configured to produce a signal relating to a tipping moment applied to the chassis of the handling machine about a tilting axis, for example located at the front axle. According to one embodiment, the stability status is determined based on the signal produced by the tilt sensor.

According to one embodiment, the safety system includes a load weighing system for determining a mass and a position of a load carried by the handling machine, the controller being configured to determine the stability state based on the mass and position of the load determined by the load weighing system. According to one embodiment, the weighing system includes a pressure sensor for producing a signal relating to pressure in a hydraulic lifting cylinder of a handling arm of the handling machine.

According to one embodiment, the computer is further configured to:
determine or predict a future geographical location based on the current geographical location and/or past geographical locations,
determine or predict a future state of stability based on the current state of stability and/or past states of stability,
determine the minimum stopping distance based on the prediction of the future geographical location and the future state of stability.

According to one embodiment, the invention also provides a handling machine comprising the aforementioned safety system. Such a handling machine may also comprise a main body mounted on wheels for moving on the ground, a handling arm for receiving a load to be moved, the handling arm being articulated about a horizontal axis relative to the main body, and an actuating device configured to execute movement of the handling arm relative to the main body, the actuating device comprising a hydraulic lifting cylinder-mounted between the handling arm and the main body to execute movement of the handling arm about the horizontal axis.

The handling machine comprises an element capable of receiving the adaptation signal and reducing the speed of movement of the handling machine in response to the adaptation signal. According to embodiments, the element for reducing the current speed of movement is part of a transmission chain or a braking system of the handling machine.

According to another aspect, the handling arm comprises at least two telescopic segments that can be extended using an extension cylinder arranged between the at least two segments.

According to one embodiment, the handling machine is configured in the form of a forklift truck with a telescopic arm.

### BRIEF DESCRIPTION OF THE FIGURES

The invention will be better understood, and other purposes, details, features and advantages thereof will become clearer in the following description of several specific embodiments of the invention, given solely for illustrative purposes and not as limitations, with reference to the accompanying drawings.

FIG. 1 is a schematic representation of a telescopic arm forklift truck in which embodiments of the invention may be implemented.

FIG. 2 is a schematic representation of a rear view of the telescopic arm forklift truck.

FIG. 3 is a schematic representation of the positioning system detecting a road sign.

FIG. 4 is a schematic representation of the different situations encountered by the anti-collision system.

FIG. 5 illustrates the technical characteristics of an example of an object sensor.

FIG. 6 is a functional representation of a handling machine comprising a safety system.

FIG. 7 is an example of a graph defining a minimum deceleration for a tractor and a handling machine as a function of their current speed.

FIG. 8 is a process diagram illustrating a safety control process.

### DESCRIPTION OF EMBODIMENTS

The following describes embodiments of a safety system 1 for a telescopic arm forklift truck 1000.

### Telescopic Arm Forklift Truck 1000

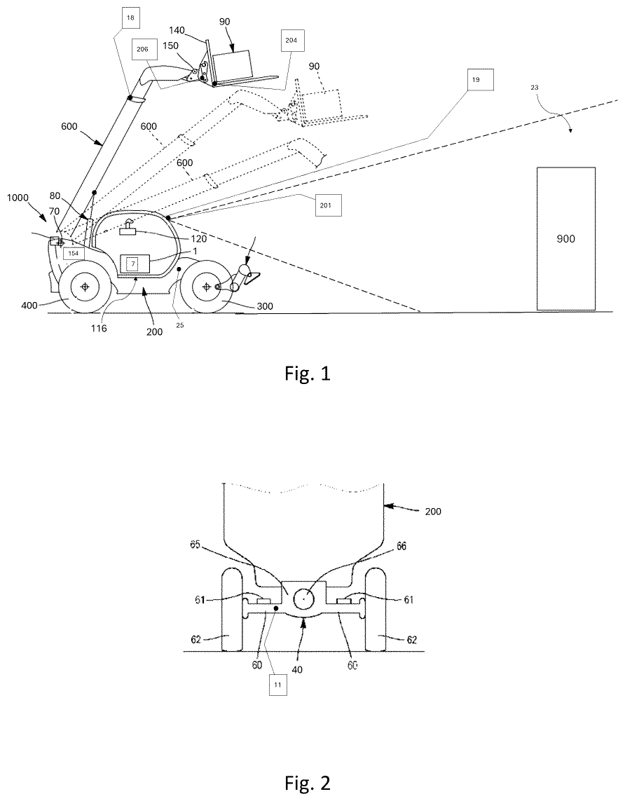

With reference to FIG. 1, the telescopic arm forklift truck 1000 comprises a chassis 200 supported on the ground by means of a front axle carrying front wheels 300 and a rear axle carrying rear wheels 400. The telescopic arm forklift truck 1000 comprises a telescopic-type handling arm 600 mounted on the chassis 200 at one end and rotatable about a rotation axis 70 transverse to the chassis 200.

In a variant not shown, the telescopic arm forklift truck 1000 may include a rotating turret allowing the handling arm to be rotated about a vertical axis, as described, for example, in publication EP3187373 A1.

The handling arm 600 comprises at least two telescopic segments that can be extended using a hydraulic extension cylinder arranged between the at least two segments.

The handling arm 600 comprises a load-bearing tool 140 articulated to a second end of the handling arm 600 by the connection 150 and configured to carry a payload 90. In the example shown, the load-bearing tool 140 is a fork, but other tools may be used, for example a bucket.

The handling arm 600 can be rotated by a hydraulic lifting cylinder 80 connected to the chassis 200 and the handling arm 600. The handling arm 600 comprises at least two telescopic segments that can be extended by means of an extension cylinder, not shown, arranged between the at least two segments. An orientation actuator, not shown, is arranged to change the orientation of the load-carrying tool about a rotation axis transverse to the chassis 200. This orientation actuator may be a hydraulic actuator.

The telescopic arm forklift truck 1000 comprises one or more transmission chains including one or more thermal or electric motors (not shown) and adapted to transmit energy generated by the motor(s) to the various actuators of the telescopic arm forklift truck 1000.

The actuators driven by the transmission chain(s) include handling actuators, such as the handling arm 600 and the load-bearing tool 140, and mobility actuators, such as the front wheels 300 and the rear wheels 400.

For example, a first motor is configured to drive the front wheels 300 and/or rear wheels 400 via a first transmission chain 500, and a second motor is configured to actuate the handling arm 600 and load-bearing tool 140 via a second transmission chain, in particular a hydraulic transmission chain.

The telescopic arm forklift truck 1000 comprises a braking system 26. The braking system 26 comprises a brake pedal 262 and one or more brake actuators 261 configured to reduce the speed of the telescopic arm forklift truck 1000. In addition, the braking system includes a brake controller 263 configured to receive a braking signal indicating a braking force that the brake actuator(s) 261 will apply to the front wheels 300 and/or rear wheels 400.

The telescopic arm forklift truck 1000 further comprises a control member 120 configured to manually control the actuators of the handling arm 600, namely the extension cylinder and/or the orientation actuator.

The control device 120 allows, in particular, the lifting arm 600 to be raised and lowered, the lifting arm 600 to be extended or retracted, and/or the orientation of the load-carrying tool 140 to be changed by means of a hydraulic system known per se.

The control element 120 may be a hydro-proportional manipulator block that delivers a hydraulic control signal. This hydraulic signal can then be converted into an electrical signal that can be communicated to a computer 7. Alternatively, the demand device 120 may be an electro-proportional manipulator block that delivers an electrical demand signal e that can be communicated to the computer 7. The demand device 120 could take other forms, such as buttons, levers, touch screens, etc.

FIG. 1 shows the handling arm 600 carrying the payload 90 in an upper, retracted position as a solid line and in several lower, extended positions as dashed lines.

The telescopic arm forklift truck 1000 comprises a running speed determination system 25 configured to determine a running speed of the telescopic arm forklift truck 1000. The current speed determination system 25 may include one or more speed sensors mounted on the telescopic arm forklift truck 1000. The on-board speed sensor(s) may include revolution counters measuring a number of revolutions of a component of the transmission system of the 1000 telescopic arm forklift or a speed of one of the front wheels 300 and/or rear wheels 400.

The telescopic arm forklift truck 1000 comprises a communication system 71 adapted to communicate with other equipment, for example a computerized fleet management system. The communication system 71 is adapted to transmit signals generated by the safety system 1, and to receive signals, for example from a remote central server. The communication system 71 is, for example, adapted to transmit the received signals to the safety system 1. In one embodiment, a maximum permissible stopping distance is transmitted by the fleet management system to be applied by the safety system 1.

With reference to FIG. 6, the safety system 1 comprises an anti-collision system 20, an anti-tipping system 27 and/or a position system 19, a first maximum distance determination system 321 and/or a second maximum distance determination system 322, and a speed limitation controller 32.

### Anti-Collision System 20

The anti-collision system 20 is capable of automatically detecting a risk of collision involving the telescopic arm forklift truck 1000 and activating the braking system 26 of the telescopic arm forklift truck 1000 in order to reduce the speed of the latter and avoid the collision or mitigate its consequences.

The anti-collision system 20 comprises one or more object sensors 201 and a distance determination sensor 203. The object sensor(s) 201 and the distance determination sensor 203 may be combined or separate. In addition, the object sensor(s) 201 and the distance determination sensor 203 may be separate from the anti-collision system and independent within the telescopic arm forklift truck 1000.

The anti-collision system 20 comprises an anti-collision controller 202 configured to process signals sent by the object sensors 201 and/or the distance determination sensor 203 and communicate with the other systems of the safety system 1.

The object sensor(s) 201 are configured to generate an object signal indicating the detection of all or part of an object 900 within a coverage zone 23.

The object sensor(s) 201 are characterized by a perception zone SR. They are capable of detecting an object positioned within their perception zone.

The object sensor(s) 201 are, in particular, adapted to detect an obstacle to the movement of the telescopic arm forklift truck 1000 or a road sign 10.

The object sensor(s) 201 may include, for example, one or more imagers (e.g., one or more cameras), one or more light detection and ranging (LIDAR) sensors, one or more sound navigation (SONAR) sensors, or one or more radio detection and ranging (RADAR) sensors, or any other type of appropriate sensor.

The object sensor(s) 201 may be mounted on the telescopic arm forklift truck 1000, for example at the front of the telescopic arm forklift truck 1000, as illustrated in FIG. 1. It is envisaged that one or more object sensors 201 may be mounted additionally and/or alternatively at many different locations on the telescopic arm forklift truck 1000.

The object sensors 201 enable the absolute or relative geographical position of the telescopic arm forklift truck 1000 to be determined.

The anti-collision system 20 is configured to analyze the object signals generated by the object sensors 201 and identify a relative position of the telescopic arm forklift truck 1000 in relation to a detected object.

For this purpose, the anti-collision system 20 includes a distance determination sensor 203. The distance determination system 203 is configured to determine a distance between the handling machine and a detected object from the object signals generated by the object sensor(s) 201. If the geographical position of the detected object is known to the location system 19, then the anti-collision system 20 can determine the absolute geographical position of the telescopic arm forklift truck 1000.

The distance determination sensor 203 is characterized by the coverage zone 23. The coverage zone 23 represents the union of all the SR perception areas of the object sensors 201. If the location system comprises a single object sensor 201, then the coverage zone 23 is the SR perception area of the single object sensor 201.

The coverage zone 23 of the distance determination system 203 is characterized by one or more representative dimensions. The coverage zone 23 may also be characterised by an angle. For example, in the horizontal plane of the environment of the telescopic forklift truck 1000, an opening angle of the coverage zone is the smallest angle having as its apex the position of the telescopic forklift truck 1000 delimiting a portion of the horizontal plane containing the coverage zone 23.

The representative dimension(s) are defined by a length and an angle relative to a direction of movement of the telescopic forklift truck 1000.

For example, the object sensor 201 may be an OHW range radar manufactured by Robert Bosch GmbH or a Sentry range radar manufactured by Sensata Technologies.

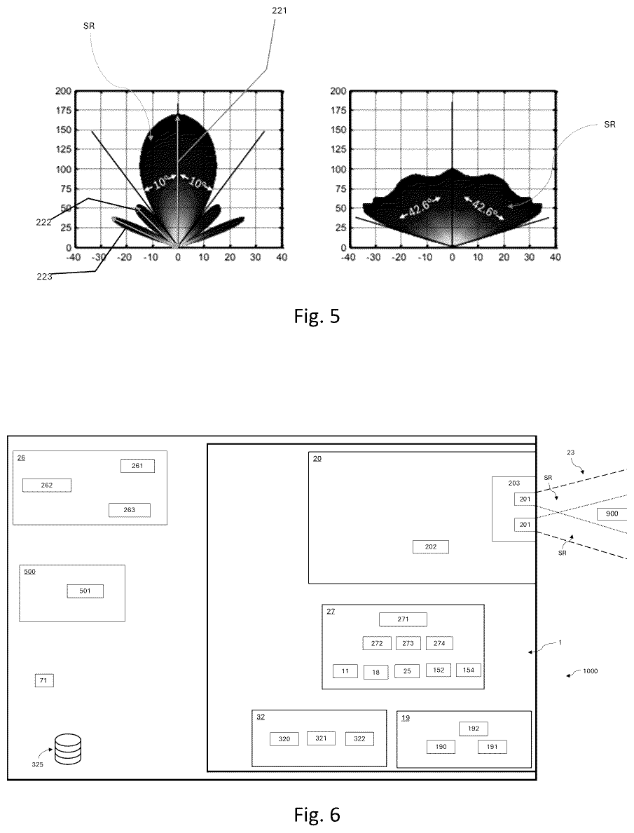

FIG. 5 illustrates a BOSCH OHW range radar in a Tx1 antenna configuration and a Tx2 antenna configuration.

In this example, a single object sensor 201 is used. Thus, the perception zone SR of the single object sensor 201 defines the coverage zone 23.

FIG. 5 illustrates the distance covered by the coverage zone 23 on the y-axis and x-axis.

In this example, the coverage zone 23 of the determination sensor 203 comprises three representative dimensions:
a first representative dimension 221 extending along the direction of movement of the telescopic forklift truck 1000, i.e. forming an angle of 0° with the direction of movement of the telescopic forklift truck 1000;
a second representative dimension 222 extending along a direction forming an angle of approximately 15° with the direction of movement of the telescopic forklift truck 1000;
a third representative dimension 223 extending along a direction forming an angle of approximately 40° with the direction of movement of the telescopic forklift truck 1000.

In the example illustrated in FIG. 5, the first representative dimension 221 is approximately 170 metres, the second representative dimension 222 is approximately 60 metres, and the third representative dimension 223 is approximately 80 metres.

In addition, the coverage zone 23 has a maximum dimension. Depending on the characteristics of the object sensors 201, the maximum dimension extends in a direction forming an angle between 0 and 80° with a direction of movement of the telescopic arm forklift truck 1000. The angle may be between 0 and 75°, 0 and 40°, 0 and 20°, or 0 and 10°.

With reference to FIG. 4, the anti-collision system 20 takes into account at least three different distances: a minimum stopping distance 260 of the telescopic arm forklift truck 1000, an activation distance 240 and a representative dimension of the coverage zone.

For example, the representative dimension considered is the first representative dimension 221 extending along the direction of movement of the telescopic forklift truck 1000, i.e. forming an angle of 0° with the direction of movement of the telescopic forklift truck 1000.

The activation distance 240 corresponds to the minimum stopping distance 260 and a safety margin 250. In other words, the activation distance 240 is the sum of the minimum stopping distance 260 and the safety margin 250.

The minimum stopping distance 260 is the distance travelled by the telescopic arm forklift truck 1000 during the total braking time, i.e. the distance travelled by the telescopic arm forklift truck 1000 from the moment a driver begins to operate a braking control device until the moment the telescopic arm forklift truck 1000 comes to a stop.

The minimum stopping distance 260 corresponds to a braking distance 231 of the telescopic arm forklift truck when the brake actuators 261 are activated and a reaction distance 232 corresponding to the distance travelled by the telescopic arm forklift truck during the reaction time of the braking system 26. In other words, the minimum stopping distance 260 is the sum of the braking distance 231 and the reaction distance 232.

The braking distance 231 takes into account the permissible deceleration determined by the anti-tipping system 27. In fact, the deceleration of the telescopic arm forklift truck 1000 during the braking phase is determined so that the telescopic arm forklift truck 1000 does not tilt forward.

The stopping distance 260, the activation distance 240 and the representative dimension 221 are not fixed: they are likely to change over time. For example, the braking distance 231 may change depending on the stability of the telescopic arm forklift truck 1000 and/or the speed of the telescopic arm forklift truck 1000. Similarly, the representative dimension 221 may change over time depending on the parameters of the object sensors 201 and/or weather conditions.

The stopping distance 260, the activation distance 240 and the representative dimension 221 define three cases:
Case A: no object 900 is detected in the coverage zone 23. Nevertheless, it is possible that an obstacle 900 is positioned outside the coverage zone 23, i.e. at a distance greater than the representative dimension 221 in relation to the telescopic arm forklift truck 1000.
Case B: an object 900 is detected in the coverage zone 23, so it is located at a distance less than the representative dimension 221 from the telescopic arm forklift truck 1000. Furthermore, the object 900 is located at a distance greater than the activation distance 240 from the telescopic arm forklift truck 1000.
Case C: an object 900 is located at a distance less than the activation distance 240 from the telescopic arm forklift truck 1000.
Case D: an object 900 is located at a distance less than the stopping distance 260 from the telescopic arm forklift truck 1000. Collision is then inevitable.

In case C, i.e. when the distance determined by the distance determination sensor 203 becomes less than the activation distance 240, the anti-collision system 20 sends a braking signal to the braking system 26 to reduce the speed of the forklift truck and avoid the collision.

The braking signal communicates the braking force to be applied to the front wheels 300 and/or rear wheels 400. Thus, the braking signal determines the deceleration of the telescopic arm forklift truck 1000 during the braking phase.

In case B, the anti-collision system 20 detects an object 900, but the telescopic arm forklift truck 1000 is far enough away to stop in time if the operator brakes. The anti-collision system 20 therefore does not trigger braking.

Case A is accident-prone. This is because no object 900 is detected in the coverage zone 23. However, by the time an object 900 is detected, the stopping distance may have become long enough for the telescopic arm forklift truck 1000 to be in case D at the time of detection. The speed limitation module 320 of the speed limitation controller 32 aims to prevent this situation.

### Anti-Tipping System 27

The anti-tipping system is configured to determine a minimum stopping distance at or above which the telescopic arm forklift truck 1000 will not tip over due at least in part to the deceleration of the telescopic arm forklift truck 1000 from the current speed of travel of the telescopic arm forklift truck 1000. The current travel speed of the telescopic arm forklift truck 1000 is the speed at which the telescopic arm forklift truck 1000 is travelling when the braking system 26 receives the braking signal sent by the anti-collision system 20.

The anti-tipping system 27 comprises a stability system 272, an admissible deceleration determination system 273 and a minimum stopping distance determination system 274. The anti-tipping system comprises an anti-tipping controller 271 adapted to process signals generated by the stability system 272, the permissible deceleration determination system 273 and the minimum stopping distance determination system 274.

The stability system 272 is configured to determine a stability state of the telescopic arm forklift truck 1000. The stability state of the telescopic arm forklift truck 1000 characterises a risk of the telescopic arm forklift truck 1000 tipping over.

Various methods for determining the stability state are possible and can be used alone or in combination with each other.

According to a first method for determining the state of stability, the telescopic arm forklift truck 1000 further comprises a tipping sensor 11 configured to produce a signal relating to a tipping moment applied to the chassis 200 about a tipping axis located at the front axle.

In one embodiment, the tilt sensor 11 is arranged at the rear axle 40.

In FIG. 2, the rear axle 40 of the telescopic arm forklift truck 1000 comprises two wheel support arms 60 carrying rear wheels 62. Each wheel support arm 60 comprises a strain gauge 61 configured to measure tensile deformation of said wheel support arm 60 in a direction perpendicular to said arm 60. Alternatively, the strain gauges 61 are configured to measure a bending deformation of the wheel support arm 60, in particular a change in length between two spaced terminals on the wheel support arm 60. The measurement signals from the strain gauges 61 can be used to form the signal indicative of the tipping moment, for example as an average of the two measurement signals. Alternatively, a single extensometer 61 may be used to produce the signal indicative of the tipping moment. Preferably, the rear axle 40 is connected in an oscillating manner to the chassis 200 by means of a pivot 66 with a longitudinal axis passing through a central part 65 of the axle.

For example, the stability system 272 determines the stability status from the signal produced by the tipping detector 11 and a correspondence table associating a tipping moment value with a stability status of the telescopic arm forklift truck 1000.

For example, the correspondence table is determined by extrapolation from at least two tipping moments measured in two different configurations and/or two different payloads 90. For example, a first tipping moment is determined in a configuration of the telescopic arm forklift truck 1000 in which the handling arm 600 is retracted and without any payload 90; and a second tipping moment is determined in a configuration of the telescopic arm forklift truck 1000 in which the handling arm 600 is extended to its maximum with a maximum payload 90. From these two tipping moments, the correspondence table is determined by extrapolation.

According to one method of determination, the stability system 272 has access to one or more databases comprising the centres of gravity of the components of the telescopic arm forklift truck 1000 in an initial configuration of the telescopic arm forklift truck 1000, for example when the handling arm 600 is retracted, and the masses of the main moving components of the telescopic arm forklift truck 1000.

For example, the masses and centres of gravity of the chassis 200, the rear axle and the front axle, the foot of the handling arm 600, each of the two telescopic segments of the handling arm 600, the load-bearing tool 140 and the apron when the telescopic arm forklift truck 1000 is in the initial configuration are provided. When the telescopic arm forklift truck 1000 is mounted on a rotating turret, the mass and centre of gravity of the turret are also entered.

Furthermore, depending on the method used to determine stability, the telescopic arm forklift truck 1000 also includes a plurality of displacement sensors 18 configured to produce a signal relating to movements of the handling arm 600 relative to the main body 200.

These displacement sensors 18 are, for example, configured to produce a signal relating to a position of the handling arm 600, in particular an angle of inclination of the handling arm 600 relative to the chassis 200 and/or an extension length of the handling arm 600, and a signal relating to movements of the load-carrying tool 140. If necessary, the telescopic arm forklift truck 1000 also includes a displacement sensor 18 configured to produce a signal relating to the movements of the turret, using a turret rotation angle sensor.

The stability system 272 is configured to receive signals from the displacement detectors 18.

The displacement sensors 18 include, for example, a first sensor located at the axis 70 and arranged to measure the angle of inclination of the handling arm 600. The displacement sensors are configured to produce a signal representative of the angle of inclination of the handling arm 600 relative to the chassis 200 based on the data from the first sensor. The displacement sensors 18 include, for example, a second sensor located at the extension cylinder and arranged to measure a stroke of said extension cylinder. The displacement sensors 18 are configured to produce a signal representative of the extension length of the handling arm 600 based on data from the second sensor.

According to a second method for determining the stability status, the telescopic arm forklift truck 1000 comprises a payload weighing system 152 and a load position determination system 154.

Furthermore, according to the second determination method, the payload weighing system 152 is connected to a pressure sensor adapted to measure the pressure in the hydraulic extension cylinder and/or a pressure sensor adapted to measure the pressure in the hydraulic lifting cylinder 80. Based on the signals generated by the payload weighing system 152, the stability system 272 determines the mass and position of the centre of gravity of the payload 90 carried on the load-carrying tool 140.

According to the second method of determining the stability status, the stability system 272 determines the stability status of the telescopic arm forklift truck 1000 based on the centres of gravity and masses of the main moving components of the telescopic arm forklift truck 1000 and the payload.

For example, based on the position of the centres of gravity and the various moving masses of the telescopic arm forklift truck in an initial configuration of the telescopic arm forklift truck 1000 and the payload 90 and one or more of the signals generated by displacement sensors 18, the stability system 272 determines the current position of the centre of gravity of the telescopic arm forklift truck equipped with the payload 90.

Then, based on the current position of the centre of gravity of the telescopic arm forklift truck equipped with the payload 90, the stability system 272 determines the static stability of the telescopic arm forklift truck 1000 and the stability state of the telescopic arm forklift truck 1000, for example, by applying the fundamental principle of dynamic. For example, the stability state may be the dynamic moment of the telescopic arm forklift truck 1000.

The telescopic arm forklift truck 1000 includes one or more payload sensors 204 configured to generate one or more signals indicating a payload (e.g., the weight of the payload 90) carried by the load-carrying tool 140. The payload determination system 152 determines the payload 90 from the signals generated by the payload sensors 204.

For example, one or more pressure sensors associated with the handling arm 600 and/or one or more pressure sensors associated with the load-carrying tool actuator 140 generate signals indicating the pressure in one or more of the hydraulic cylinders, which are indicative of the payload 90 carried by the load-carrying tool 140.

Other methods of determining the payload 90 implemented by the payload determination system 152 are contemplated, such as estimates based at least in part on, for example, the type of material, the density of the material, and/or the volume of the load-carrying tool 140, and signals indicative of such estimates may be generated and used via the payload determination system 152.

The telescopic arm forklift truck 1000 may also include (and/or receive one or more signals from) one or more hitch position sensors 206 configured to generate one or more signals indicating at least one of:
a position of the handling arm 600 and/or the load-carrying tool 140; and/or
an orientation of the handling arm 600 and/or the load-carrying tool 140 relative to the telescopic arm forklift truck 1000.

The load position determination system 154 uses these signals to determine an effective position of the payload 90, for example, relative to a centre of gravity of the telescopic arm forklift truck 1000 (e.g., without the payload 90). For example, the hitch position sensor(s) 206 comprise one or more sensors configured to generate one or more signals indicating a pivot position of the handling arm 600 relative to the chassis 200, and/or indicating a pivot position of the load-carrying tool 140 relative to the handling arm 600. In some examples, one or more hitch position sensors 206 are configured to generate one or more signals indicating an extension (or retraction) length position of the cylinder 80 and/or a cylinder of the load-carrying tool 140.

In the example illustrated in FIG. 1, the pivot position of the handling arm 600 relative to the chassis 200 is fixed. However, another configuration of the handling machine may allow for a movable pivot position of the handling arm 600 relative to the chassis 200.

According to the second method of determining the stability condition, the weight of the payload 90 determined by the payload determination system 152 and the position of the payload 90 determined by the load position determination system 154 are used by the stability system 272 to determine an effective centre of gravity of the telescopic arm forklift truck 1000 in its loaded state and a variation in the position of the effective centre of gravity relative to a position of the effective centre of gravity in an unloaded state of the telescopic arm forklift truck 1000.

For example, relative to an unloaded state, when the telescopic arm forklift truck 1000 is carrying a payload 90 in the load-carrying tool 140, the effective centre of gravity of the telescopic arm forklift truck 1000 in its loaded state moves upwards and forwards.

When the position of the payload 90 changes upwards (e.g., the handling arm 600 is raised), the effective centre of gravity moves upwards relative to the unloaded centre of gravity. When the payload 90 is moved forward (e.g., the boom is positioned with the payload further forward of a cab 116 of the telescopic arm forklift truck 1000), the effective centre of gravity moves forward relative to the unloaded centre of gravity.

As the effective centre of gravity moves forward and upward, the tendency of the telescopic arm forklift truck 1000 to tip forward increases. Thus, according to the second method of determining the stability state, the stability system 272 determines the stability state of the telescopic arm forklift truck 1000 based on the determination of the effective centre of gravity and/or the variation in the position of the effective centre of gravity relative to a position of the effective centre of gravity in an unloaded state.

The anti-tipping system 27 may also comprise a system for determining an inclination of the telescopic arm forklift truck 1000 relative to the ground and/or relative to the chassis 200.

The permissible deceleration determination system 273 is configured to determine a permissible deceleration based on the stability state. The permissible deceleration allows the handling machine to be stopped without causing the handling machine to tip over.

In some examples, the permissible deceleration may be calculated in real time by the permissible deceleration determination system 273 from the stability state based on known physical principles, and/or empirically based, for example, on tests established at different stability states and/or known physical principles.

For example, based on the state of stability, the permissible deceleration determination system 273 determines the maximum possible deceleration, for example by an analytical approach or by dichotomy.

When the permissible deceleration is at least partially determined empirically, a plurality of empirical permissible decelerations may be correlated with machine-related parameters in one or more lookup tables.

The anti-collision system 20 determines the braking force to be applied to the front wheels 300 and/or rear wheels 400 in accordance with the permissible deceleration determined by the permissible deceleration determination system 273.

Based on the permissible deceleration and the current speed of the telescopic arm forklift truck 1000, the minimum stopping distance determination system 274 determines a braking distance 231.

The braking distance 231 thus takes into account the permissible deceleration determined by the anti-tipping system 27. In fact, the deceleration of the telescopic arm forklift truck 1000 during the braking phase is less than or equal to the permissible deceleration, so that the telescopic arm forklift truck 1000 does not tip forward.

Based on the braking distance 231, the minimum stopping distance determination system 274 determines a minimum stopping distance 260.

This minimum stopping distance 260 is the stopping distance at or above which the telescopic arm forklift truck 1000 will not tip over due to its deceleration from the travelling speed at which the telescopic arm forklift truck 1000 is travelling to a stopped condition.

In some examples, the minimum stopping distance 260 may be calculated in real time based on known physical principles and information obtained from the load position determination system 154 and/or the payload determination system 152, and/or may be determined empirically based on, for example, tests and/or known physical principles.

When the minimum stopping distance 260 is at least partially determined empirically, the empirical minimum stopping distances can be correlated with machine-related parameters in one or more lookup tables, for example, and the minimum stopping distance 260 can be determined based on one or more machine-related parameters.

The minimum stopping distance determination system 274 is further adapted to calculate the minimum stopping distance 260 taking into account a reaction distance 232 corresponding to a distance travelled during a reaction time of an element of the telescopic arm forklift truck 1000 to reduce the speed of movement of the telescopic arm forklift truck 1000. The reaction distance 232 depends on the reaction time and the current speed of the telescopic arm forklift truck.

The minimum stopping distance determination system 274 is further adapted to calculate an adaptation distance 240 taking into account the minimum stopping distance 260.

For example, with reference to FIG. 4, the adaptation distance 240 is determined based on a safety margin representing a reaction time of the machine element. Thus, the adaptation distance 240 is the sum of the minimum stopping distance 260 and the safety margin 250. The safety margin may be zero. In this case, the adaptation distance 240 is equal to the minimum stopping distance 260.

The anti-tipping system 27 may also use the tipping detector 11 and/or the displacement sensors 18 to prevent or restrict movements of the handling arm 600 that would jeopardize the stability of the telescopic arm forklift truck 1000, according to known technology.

### Location System 19

The telescopic arm forklift truck 1000 comprises a location system 19 for acquiring location data for the handling machine.

The location system 19 may comprise one or more positioning systems 191 determining an absolute or relative geographical position.

The location system 19 may comprise a satellite geolocation positioning system or a GSM geolocation positioning system using the antennas and technologies of mobile telephone networks designed for voice and data transfer, such as GSM, UMTS or LTE.

The location system 19 may also comprise a Wi-Fi geolocation system. In the same way that a GSM terminal can locate itself on a GSM mobile network, a Wi-Fi terminal can use the same method based on the identifiers of the Wi-Fi access points (SSID or MAC addresses) that it detects.

The location system 19 may also include an RFID geolocation system. To do this, a series of RFID readers equipped with different types of antennas are positioned to cover an entire desired area, such as a construction site or the interior of a factory.

Satellite geolocation, GSM geolocation, Wi-Fi or RFID positioning systems can be used to determine the absolute geographical position of the telescopic arm forklift truck 1000. They can be used in combination with the location system 19.

In addition, the current speed determination system 25 can determine the current speed of the telescopic arm forklift truck from the geographical positions determined by the location system 19.

Alternatively or cumulatively, the location system 19 comprises one or more of the environment sensors 192.

The environmental sensor(s) 192 are capable of detecting an object positioned in the environment near the telescopic arm forklift truck 1000 and are configured to generate an object signal indicating the detection of all or part of an object in the environment near the telescopic arm forklift truck 1000.

The environment near the telescopic arm forklift truck 1000 may be a zone centred on the telescopic arm forklift truck 1000, for example a circle or an ellipse. The environment close to the telescopic arm forklift truck 1000 may refer to a circle centred on the telescopic arm forklift truck 1000 with a radius between 0 and 10 metres, 0 and 20 metres, 0 and 30 metres, 0 and 40 metres, 0 and 50 metres. Similarly, the immediate environment of the telescopic arm forklift truck may be an ellipse centred on the telescopic arm forklift truck 1000 with a semi-major axis and/or semi-minor axis between 0 and 10 metres, 0 and 20 metres, 0 and 30 metres, 0 and 40 metres, 0 and 50 metres.

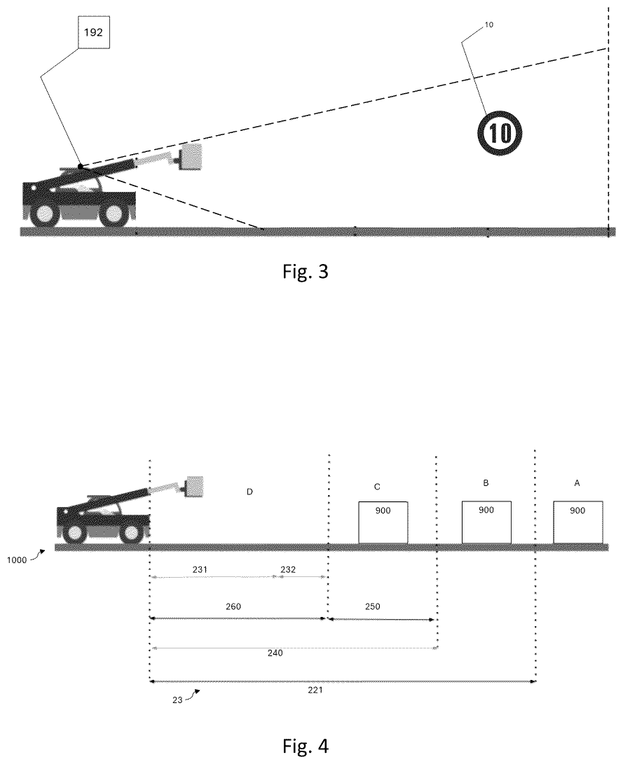

As illustrated in FIG. 3, the environment sensor(s) 192 are, in particular, adapted to detect a road sign 10 in the immediate vicinity of the telescopic arm forklift truck 1000.

The environmental sensor(s) 192 may include, for example, one or more imagers (e.g., one or more cameras), one or more light detection and ranging (LIDAR) sensors, one or more sound navigation (SONAR) sensors, or one or more radio detection and ranging (RADAR) sensors, or any other type of appropriate sensor.

The position system 19 is adapted to determine a relative position of the telescopic arm forklift truck 1000 with respect to an object located in the environment close to the telescopic arm forklift truck 1000.

The environment sensor(s) 192 may include one or more object sensors 201.

The location system 19 comprises a location controller 190 configured to process signals generated by the positioning system(s) 191 and/or the environment sensor(s) 192. The location controller 190 is also adapted to communicate with the other systems of the safety system 1.

### Speed Limitation Controller 32

The safety system 1 comprises a speed limitation controller 32 adapted to limit a current speed of the telescopic arm forklift truck 1000.

To do this, the speed limitation controller 32 comprises a speed limitation module 320 configured to compare a maximum permissible stopping distance and the minimum stopping distance 260, or, where applicable, the adaptation distance 240.

Several methods for determining the maximum stopping distance may be used by the speed limitation controller 32. These methods may be used separately or in combination to determine the maximum stopping distance. For example, a first maximum distance determination system 321 determines a first maximum permissible stopping distance by implementing a first method for determining the maximum permissible stopping distance, and a second maximum distance determination system 322 determines a second maximum permissible stopping distance by implementing a second method for determining the maximum permissible stopping distance.

The maximum permissible stopping distance selected is then the first maximum stopping distance or the second maximum stopping distance or the smallest distance between the first maximum permissible stopping distance and the second maximum permissible stopping distance.

The combination of two methods for determining the maximum stopping distance can be generalized to any integer number of methods.

The speed limitation controller 32 comprises a first system for determining a maximum distance 321.

In order to determine the first maximum stopping distance, the first maximum distance determination system 321 may have access to one or more databases 325 containing regulatory information relating to the maximum distance. The database or databases 325 may be accessible via local or remote access. Thus, the first maximum distance determination system 321 may determine the first maximum stopping distance by accessing one or more of the databases 325.

According to a first determination method, the first maximum distance determination system 321 determines a first permissible maximum stopping distance based on the location data of the telescopic arm forklift truck 1000.

This first determination method proposes to take into account a relative position of the telescopic arm forklift truck 1000 in its environment or an absolute position of the telescopic arm forklift truck 1000 to determine a speed of movement of the telescopic arm forklift truck 1000 that ensures that the telescopic arm forklift truck 1000 is capable of stopping safely at any time.

As described above, the location system 19 is adapted to determine a relative or absolute position of the telescopic arm forklift truck.

Based on the relative or absolute position of the telescopic arm forklift truck 1000, the first maximum distance determination system 321 determines the first maximum permissible stopping distance.

The first maximum distance determination system 321 determines the first maximum permissible stopping distance defined by a regulation applicable to the relative or absolute position of the telescopic arm forklift truck 1000.

The location system 19 can determine a relative location of the telescopic arm forklift truck 1000 in relation to elements in its environment, in particular in relation to road signs.

The first maximum distance determination system 321 can extract information from the analysis of these images, for example regulatory information. The first maximum distance determination system 321 then determines the first maximum permissible stopping distance based on the extracted information and, where applicable, regulatory information applicable to this absolute location contained in one or more of the databases accessible by the first maximum distance determination system 321.

In one example, an environment sensor 192 of the location system 19 identifies a road sign 10. The location system 19 determines a relative position of the telescopic arm forklift truck with respect to this road sign 10 and/or a distance of the telescopic arm forklift truck with respect to this road sign 10.

The first maximum distance determination system 321 is adapted to identify, from the signals generated by the object sensor 201, regulatory information contained in the road sign 10.

The first maximum distance determination system 321 may consider that this regulatory information applies to the telescopic arm forklift truck 1000 as soon as a road sign is detected in the immediate environment or if the distance between the telescopic arm forklift truck and this road sign 10 is or becomes less than a predetermined threshold.

The first maximum distance determination system 321 then determines the first maximum permissible stopping distance based on the regulatory information contained in the road sign 10.

For example, the traffic sign indicates a maximum permitted speed of 10 km/h. Based on information contained in one or more of the databases to which the first maximum distance determination system 321 has access, the first maximum distance determination system 321 determines a minimum deceleration corresponding to a maximum permitted speed of 10 km/h. For example, the first maximum distance determination system 321 determines that the minimum deceleration is 3.5 m·s⁻² based on EU Directive No. 167/2013, or the first maximum distance determination system 321 determines that the minimum deceleration is 2 m·s⁻² based on ISO standard 62742. Based on this minimum deceleration, the first system for determining a maximum distance 321 determines the maximum permissible stopping distance in the vicinity of the traffic sign. Thus, the first system for determining a maximum distance 321 has determined the maximum permissible stopping distance based on the relative position of the telescopic arm forklift truck 1000.

In another example, the location system 19 determines an absolute position of the telescopic arm forklift truck 1000. The first maximum distance determination system 321 determines the first maximum permissible stopping distance from this absolute location and, where applicable, regulatory information applicable to this absolute location contained in one or more of the databases accessible by the first maximum distance determination system 321.

For example, the location system 19 determines the GPS coordinates of the telescopic arm forklift truck 1000.

Based on these GPS coordinates, the first maximum distance determination system 321 determines that the telescopic arm forklift truck 1000 is located on a construction site subject to regulations regarding maximum permissible stopping distance. Based on information contained in one or more of the databases to which the first maximum distance determination system 321 has access, the first maximum distance determination system 321 determines the regulations applied at the construction site and determines the maximum permissible stopping distance. The regulations may stipulate that the maximum permissible stopping distance depends on the current speed of the telescopic arm forklift truck 1000. Thus, the first maximum distance determination system 321 determined the first maximum permissible stopping distance based on the absolute position of the telescopic arm forklift truck.

In another example, the location system 19 determines that the telescopic arm forklift truck 1000 has passed through a predetermined geographical area, for example, an entrance to a factory or construction site. In this case, the location system 19 may not know the absolute position of the telescopic arm forklift truck 1000, but its passage through a predetermined geographical area determines the first maximum permissible stopping distance.

Alternatively or cumulatively, the first maximum distance determination system 321 may also take into account the weather conditions in a geographical area in which the telescopic arm forklift truck 1000 is located.

The geographical area may be a construction site on which the telescopic arm forklift truck is used. It may be determined based on information contained in one or more of the databases 325. For example, the database(s) 325 include(s) a map defining the geographical area.

The geographical area may also be determined by location data acquired by the location system 19.

For example, one or more of the databases 325 include a plurality of climatic situations, and a first maximum permissible stopping distance is associated with each of the climatic situations in the plurality of climatic situations.

The first maximum distance determination system 321 then determines the first maximum distance corresponding to the current climatic situation of the geographical area. The current climatic situation of the geographical area can be determined by the telescopic arm forklift truck 1000 from one or more suitable sensors known per se or communicated to the telescopic arm forklift truck 1000 and transmitted to the first maximum distance determination system 321.

A variation relative to the maximum permissible stopping distance may also be associated with each of the climatic conditions of the plurality of climatic conditions. Thus, the first maximum distance determination system 321 may determine the first maximum permissible distance from an initial value and the variation associated with the climatic conditions of the geographical area. This initial value may be a maximum permissible stopping distance determined by another determination method, for example from the location data of the telescopic arm forklift truck 1000 as described above.

Alternatively or cumulatively, the first maximum distance determination system 321 may also take into account timestamp data, for example in the form of a time calendar. For example, each hour or time slot in the time calendar is associated with a first maximum permissible stopping distance or a variation relative to the maximum permissible stopping distance.

Thus, the first maximum distance determination system 321 can determine the first maximum permissible distance from an initial value and the variation associated with the current time or time slot. This initial value may be a maximum permissible stopping distance determined by another determination method, for example based on location data from the telescopic arm forklift truck 1000 and/or depending on the weather conditions in a geographical area in which the telescopic arm forklift truck 1000 is located, as described above.

Alternatively or cumulatively, the first system for determining a maximum distance 321 may also take into account a number of handling machines present in the geographical area. A plurality of thresholds relating to the number of handling machines present in the geographical area is defined; i.e. ranges of numbers of handling machines are determined based on these thresholds.

A first maximum permissible stopping distance or a variation relative to the maximum permissible stopping distance is associated with each range of numbers of handling machines.

Thus, the first system for determining a maximum distance 321 can determine the first maximum permissible distance from an initial value and the variation associated with the number of handling machines present in the geographical area. This initial value can be a maximum permissible stopping distance determined by another determination method, for example from the location data of the telescopic arm forklift truck 1000 and/or based on a weather situation in a geographical area in which the telescopic arm forklift truck 1000 is located and/or based on timestamp data as described above.

The first maximum distance determination system 321 may also determine the first maximum stopping distance by receiving this first maximum stopping distance from a separate system, for example a remote central server. In this case, the remote server is adapted to transmit a maximum stopping distance to the first maximum distance determination system 321.

Finally, the first maximum distance determination system 321 may also determine the first maximum stopping distance by applying a machine parameter previously entered by a user. The first maximum permissible distance is then a parameter of the safety system 1.

The speed limitation controller 32 comprises a second maximum distance determination system 322.

According to the second determination method, the second maximum permissible stopping distance is determined based on a dimension representative of the coverage zone of the distance determination sensor of the telescopic arm forklift truck 1000.

This second determination method proposes to take into account the coverage zone of the distance determination sensor to determine a travel speed of the telescopic arm forklift truck 1000 that ensures that the telescopic arm forklift truck 1000 is capable of stopping safely at all times.

The second maximum distance determination system 322 determines the second maximum permissible stopping distance so that it is equal to or less than a representative dimension of the coverage zone.

As explained above, the coverage zone 23 of the distance determination sensor 203 is characterized by one or more representative dimensions, and the representative dimension(s) are defined by a length and an angle relative to a direction of movement of the telescopic arm forklift truck 1000.

According to a first example, the second maximum distance determination system 322 considers the representative dimension 221 forming a zero angle with respect to the direction of movement of the telescopic forklift truck 1000. In the example presented above, the representative dimension forming a zero angle with respect to the direction of movement of the telescopic forklift truck 1000 is the first representative dimension 221. The maximum distance determination system 32 then determines the second maximum permissible stopping distance so that it is equal to or less than the representative dimension forming a zero angle with the direction of movement of the telescopic forklift truck 1000.

According to a second example, the second maximum distance determination system 322 considers the maximum dimension of the coverage zone 23 as the representative dimension of the coverage zone 23. The maximum distance determination system 32 determines the second maximum permissible stopping distance so that it is equal to or less than the maximum dimension of the coverage zone 23.

The selection of the representative dimension considered by the second maximum distance determination system 322 to determine the second maximum permissible stopping distance is predetermined by a user of the telescopic arm forklift truck 1000 or determined by the second maximum distance determination system 322. In the latter case, the second maximum distance determination system 322 may select the representative dimension taken into account by considering the current speed of the telescopic arm forklift truck 1000.

The safety system 1 aims to ensure that the handling machine is capable of stopping safely at any time under the conditions imposed by the location of the handling machine.

In particular, safety system 1 aims to ensure that the telescopic arm forklift truck 1000 never finds itself in the situation described above in Case D.

To do this, the speed limitation module 320 compares the maximum permissible stopping distance with the minimum stopping distance 260 or, where applicable, the adaptation distance 240.

If the speed limitation module 320 determines that the maximum permissible stopping distance is less than the minimum stopping distance 260, the telescopic arm forklift truck is not safe and/or poses a danger to its surroundings. In other words, the minimum stopping distance 260 is greater than the maximum permissible stopping distance.

In response, the speed limitation controller 32 transmits an adjustment signal to a component of the telescopic arm forklift truck 1000 to reduce the current travel speed so that the minimum stopping distance 260 becomes less than or equal to the maximum permissible stopping distance.

The telescopic arm forklift truck component 1000 is part of the transmission chain or braking system 26 of the telescopic arm forklift truck 1000.

For example, the speed limitation controller 32 may control one or more of the brake actuators 261 in order to reduce the current travel speed so that the adaptation distance 240 becomes less than or equal to the maximum permissible stopping distance.

Alternatively or cumulatively, the speed limitation controller 32 may control the combustion engine or electric motor to reduce the travel speed or one or more elements 501 of the first transmission chain 500 so as to reduce the power transmitted by the engine 5 to the front wheels 300 and/or rear wheels 400. Thus, the speed of the telescopic arm forklift truck 1000 can decrease until the minimum stopping distance 260 becomes less than or equal to the maximum permissible stopping distance.

Alternatively or cumulatively, the speed limitation controller 32 may inhibit a request to increase the travel speed transmitted by the request device 120 so that the current speed of the telescopic arm forklift truck 1000 decreases and, ultimately, the minimum stopping distance 260 becomes less than or equal to the maximum permissible stopping distance.

Similarly, if the speed limitation module 320 determines that the maximum permissible stopping distance is less than the adaptation distance 240, the telescopic arm forklift truck 1000 is not safe and/or poses a danger to its environment. In response, the speed limitation controller 32 transmits an adaptation signal to an element of the handling machine to reduce the current travel speed so that the adaptation distance 240 becomes less than or equal to the maximum permissible stopping distance.

The examples described above concerning the transmission of the adaptation signal to the handling machine component to reduce the current travel speed so that the minimum stopping distance 260 becomes less than or equal to the maximum permissible stopping distance can be applied similarly to make the activation stopping distance less than or equal to the maximum permissible stopping distance.

The safety system 1 described above is a reactive system. Continuously, or in real time, the location system 19 and the computer 7 perform the operations described above to ensure that the handling machine is capable of stopping safely at any time under the conditions imposed by the location of the handling machine.

The safety system 1 enables the implementation of a safety control process 10,000 illustrated in FIG. 8.

In step 1, the stability system 272 determines the stability status of the telescopic arm forklift truck 1000.

In step 2, the permissible deceleration determination system 273 determines a permissible deceleration based on the stability status.

In step 3, the minimum stopping distance determination system 274 determines a minimum stopping distance 260 based on the permissible deceleration and a current travel speed of the telescopic arm forklift truck 1000.

In step 4, the first maximum distance determination system 321 determines a first permissible maximum stopping distance by implementing the first method for determining the permissible maximum stopping distance and/or the second maximum distance determination system 322 determines the second permissible maximum stopping distance by implementing a second method for determining the permissible maximum stopping distance. Where applicable, the smallest of the maximum stopping distances is retained by the speed limitation module 320.

In step 5, the speed limitation module 320 compares the maximum permissible stopping distance and the minimum stopping distance 260, or, where applicable, the adaptation distance 240.

In step 6, in response to determining that the minimum stopping distance 260 or the adaptation distance 240 is or becomes greater than the maximum permissible stopping distance, the speed limitation controller 32 transmits an adaptation signal to an element of the telescopic arm forklift truck 1000 to reduce the current travel speed so that the minimum stopping distance 260 or the reference stopping distance 240 becomes less than or equal to the maximum permissible stopping distance.

Step 4 may be performed at any time during the process.

### Predictive Mode

The safety system 1 can also operate in predictive mode. In this case, it is a predictive system that determines a future geographical location and a state of stability at a predetermined time horizon.

The time horizon may be in the order of seconds or minutes. For example, the safety system may operate in predictive mode with a time horizon of between 5 and 60 seconds or between 60 seconds and 5 minutes. In another example, the time horizon is equal to the reaction time of an element of the telescopic arm forklift truck 1000 configured to reduce the speed of movement of the telescopic arm forklift truck 1000.

In predictive mode, the safety system 1 is configured to determine or predict a future geographical location based on the current geographical location and/or past geographical locations of the telescopic arm forklift truck 1000.

The safety system 1 is configured to determine or predict a future stability state based on the current stability state and/or past stability states of the telescopic arm forklift truck 1000, the current geographical location and/or past geographical locations of the telescopic arm forklift truck 1000.

For example, the safety system 1 may consider one or more stability state variation profiles and determine the future stability state based on the current stability state and/or past stability states of the telescopic arm forklift truck 1000 and a selected stability state variation profile. The selection may be made based on the current or future geographical location of the telescopic arm forklift truck 1000.

In another example, the safety system 1 may consider the future stability state to be identical to the current stability state. For example, when the time horizon is equal to the reaction time of an element of the telescopic arm forklift truck 1000 configured to reduce the speed of movement of the telescopic arm forklift truck 1000, safety system 1 considers the future stability state to be identical to the current stability state.

Based on the prediction of the future geographical location and the future stability state, safety system 1 determines a minimum stopping distance 260 or an activation stopping distance according to the steps previously described for reactive mode.

Similarly, in predictive mode, if the safety system 1 determines that the maximum permissible stopping distance is less than the minimum stopping distance 260, the telescopic arm forklift truck will not be safe and/or will endanger its environment within the specified time horizon.

Predictive mode is particularly advantageous when the time horizon is equal to the reaction time of a component of the telescopic arm forklift truck 1000 configured to reduce the speed of the telescopic arm forklift truck 1000, as this allows the adaptation signal to be transmitted earlier and thus anticipates the reaction time.

The operations performed by the brake controller 263, speed limitation controller 32, anti-tipping controller 271, location controller 190 and/or anti-collision controller 202 may be implemented in software, hardware, application logic or a combination of software, hardware and application logic. The software, application logic and/or hardware may reside on the telescopic arm forklift truck 1000, on a separate device or on a plurality of devices. If desired, a portion of the software, application logic and/or hardware may reside on the telescopic arm forklift truck 1000, a portion of the software, application logic and/or hardware may reside on a separate device, and a portion of the software, application logic and/or hardware may reside on a plurality of devices. In one embodiment, the application logic, software or set of instructions is stored on one of a variety of conventional computer-readable media. In the context of this document, a “computer-readable medium” may be any medium or means that can contain, store, communicate, propagate or transport the instructions for use by or in connection with an instruction-executing system, apparatus or device, such as a computer. A computer-readable medium may include a computer-readable storage medium, which may be any medium or means that can contain, or store the instructions for use by or in connection with an instruction-executing system, apparatus, or device, such as a computer.

For example, the operations performed by the safety system 1 are performed by one or more computers. The computer(s) are configured to perform a plurality of steps or operations, described above, to ensure that the handling machine is capable of stopping safely at any time under the conditions imposed by the location of the handling machine.

The computer(s) comprise at least one processor; and at least one memory comprising a computer program code, the at least one memory and the computer program code being configured to, with the at least one processor, cause the operations performed by the brake controller 263, the speed limitation controller 32, the anti-tipping controller 271, the location controller 190 and/or the anti-collision controller 202.

The computer(s) has access to one or more databases 325 containing regulatory information relating to a minimum deceleration applicable to a geographical position or geographical area and/or a maximum permissible stopping distance applicable to a geographical position or geographical area.

For example, the regulatory information may include graphs defining a minimum deceleration as a function of a current travel speed to be observed at a geographical position or geographical area.

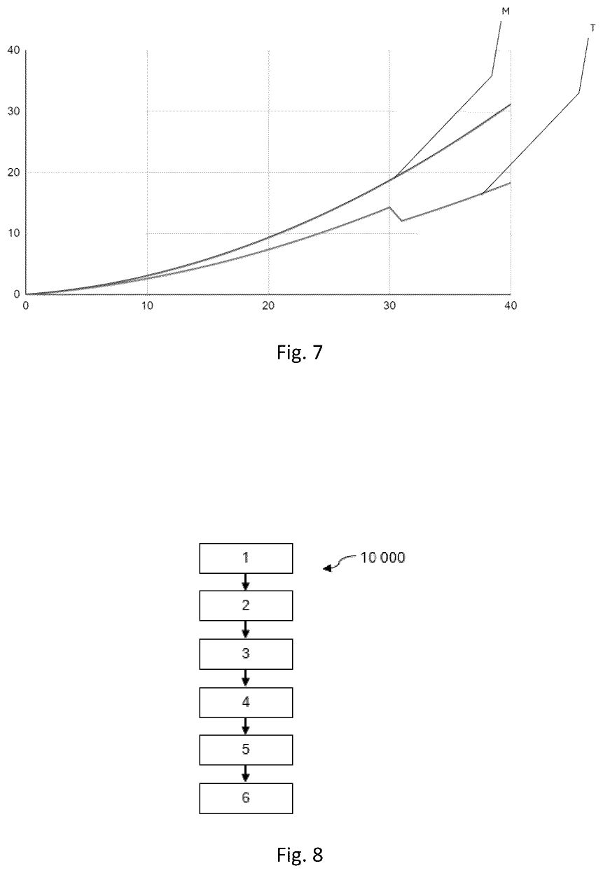

For example, FIG. 7 is an example of a graph defining, for a tractor T and a handling machine M, for example the telescopic arm forklift truck 1000, the maximum stopping distance as a function of their current travel speed.

The safety system 1 has been described in an embodiment applied to a telescopic arm forklift truck 1000.

The various sensors described above can be used in common by several systems of the telescopic arm forklift truck 1000.

The safety system 1 described above with reference to a telescopic arm forklift truck 1000 can also be used in various handling machines, for example in the form of a lifting crane, aerial platform, bucket loader or other.

Although the invention has been described in conjunction with several specific embodiments, it is clear that it is in no way limited to these and that it includes all technical equivalents of the means described as well as combinations thereof if they fall within the scope of the invention.

The use of the verbs “comprise”, “have” or “include” and their conjugated forms does not exclude the presence of other elements or steps than those stated in a claim.

In the claims, any reference sign between parentheses shall not be interpreted as a limitation of the claim.

1. Safety system (1) for a handling machine (1000), the safety system comprising:
a distance determination sensor (203) for mounting in the handling machine, the distance determination sensor being configured to determine a distance between the handling machine and an object (900) positioned within a coverage zone (23),
a controller configured to:
determine a stability state of the handling machine,
determine an allowable deceleration of the handling machine based on the stability state, the allowable deceleration being capable of stopping the handling machine without causing the handling machine to tip over,
determine a minimum stopping distance (260) based on a current travel speed of the handling machine (1000) and the permissible deceleration,
determine a maximum permissible stopping distance based on a representative dimension (221; 222; 223) of the coverage zone of the distance determination sensor (203),
in response to determining that the minimum stopping distance (260) or a reference stopping distance (240) dependent on the minimum stopping distance is or becomes greater than the maximum permissible stopping distance, transmit an adaptation signal to an element of the handling machine to reduce the current travel speed so that the minimum stopping distance (260) or the reference stopping distance (240) becomes or remains less than or equal to the maximum permissible stopping distance.

2. Safety system according to the preceding claim, wherein:
the distance determination sensor (203) comprises one or more object sensors (201) configured to generate an object signal indicating the detection of all or part of an object (900) in the coverage zone (23),
the distance determination sensor (203) being configured to determine the distance between the handling machine (1000) and the object positioned in the coverage zone from the object signals generated by the object sensor(s) (201).

3. Safety system according to the preceding claim, wherein the object sensor(s) (201) are each characterized by a perception zone (SR), the object sensor(s) being capable of detecting an object positioned within their perception zone (SR), the coverage zone (23) being the union of the perception zones (SR).

4. Security system according to any one of claims 2 to 3, wherein the object sensor(s) (201) comprise one or more imagers one or more light detection and ranging (LIDAR) sensors, one or more sonar navigation sensors (SONAR), and/or one or more radio detection and ranging sensors (RADAR).

5. Safety system according to any one of the preceding claims, wherein the at least one representative dimension (221; 222, 223) of the coverage zone is a representative dimension (221) forming a zero angle with the direction of movement of the handling machine.

6. Safety system according to any one of the preceding claims, wherein the at least one representative dimension (221; 222, 223) of the coverage zone is a smallest dimension among a plurality of representative dimensions of the coverage zone.

7. Safety system according to any one of the preceding claims, wherein the at least one representative dimension (221; 222, 223) of the coverage zone is predetermined and stored in a database accessible by the computer.

8. Safety system according to any one of the preceding claims, wherein the reference stopping distance (240) exceeds the minimum stopping distance (260) by a safety distance (250).

9. Safety system according to any one of the preceding claims, further comprising a load weighing system (152) for determining a mass and a position of a load carried by the handling machine, the controller being configured to determine the stability state based on the mass and position of the load determined by the load weighing system.

10. Safety system according to any one of the preceding claims, further comprising an anti-collision system (20) configured to automatically detect a risk of collision with an object positioned within the coverage zone (23) of the handling machine based on the distance between the handling machine and the object positioned within the coverage zone, and to activate a braking system (26) of the handling machine in order to reduce the speed of the handling machine and avoid the collision or mitigate its consequences.

11. Handling machine comprising a safety system according to any one of the preceding claims, the handling machine comprising a main body mounted on wheels for moving on the ground, a handling arm (600) for receiving a load to be moved, the handling arm being articulated about a horizontal axis relative to the main body, and an actuator configured to perform movement of the handling arm relative to the main body, the actuator comprising a hydraulic lifting cylinder mounted between the handling arm and the main body to perform movement of the handling arm about the horizontal axis, the handling machine comprising a component capable of receiving the adaptation signal and reducing the current speed of movement in response to the adaptation signal.

12. Handling machine according to the preceding claim, wherein the handling arm comprises at least two telescopic segments deployable by means of an extension cylinder arranged between the at least two segments.

13. Handling machine according to any one of claims 11 to 12 configured in the form of a telescopic arm forklift truck.

14. Handling machine according to any one of claims 11 to 13, wherein the element for reducing the current speed of movement is part of a transmission chain or a braking system (26) of the handling machine.

15. Safety control method (10,000) comprising the following steps:
determining a stability state of a handling machine (1000),
determining an allowable deceleration of the handling machine based on the stability state, the allowable deceleration being capable of stopping the handling machine without causing the handling machine to tip over,
determining a minimum stopping distance (260) based on a current speed of movement of the handling machine (1000) and the permissible deceleration,
determining a maximum permissible stopping distance based on a representative dimension (221; 222; 223) of a coverage zone of a distance determination sensor (203) carried on board the handling machine, the distance determination sensor being configured to determine a distance between the handling machine and an object (900) positioned in the coverage zone (23),
in response to determining that the minimum stopping distance (260) or a reference stopping distance (240) dependent on the minimum stopping distance is or becomes greater than the maximum permissible stopping distance, transmitting an adaptation signal to an element of the handling machine to reduce the current travel speed so that the minimum stopping distance (260) or the reference stopping distance (240) becomes or remains less than or equal to the maximum permissible stopping distance.
